(19) United States
(12) Patent Application Publication
(10) Pub. No.: US 2013/0125791 A1
(43) Pub. Date: May 23, 2013

(54) IN-PROCESS ADDITION OF PROPERTY-ENHANCING ADDITIVES TO COAL COMBUSTION PRODUCTS USED IN CEMENTICIOUS MATERIALS

(71) Applicant: ASH IMPROVEMENT TECHNOLOGY, INC., Maspeth, NY (US)

(72) Inventors: Wayne Fried, Maspeth, NY (US); Paul J. Sandberg, Beverly, MA (US)

(73) Assignee: ASH IMPROVEMENT TECHNOLOGY, INC., Maspeth, NY (US)

(21) Appl. No.: 13/741,071

(22) Filed: Jan. 14, 2013

Related U.S. Application Data
(63) Continuation-in-part of application No. 12/889,100, filed on Sep. 23, 2010.
(60) Provisional application No. 61/245,594, filed on Sep. 24, 2009.
(60) Provisional application No. 61/585,694, filed on Jan. 12, 2012.
(60) Provisional application No. 61/586,728, filed on Jan. 13, 2012.

(51) Int. Cl. B28C 5/02

(52) U.S. Cl. CPC B28C 5/02
USPC 106/705; 366/336

(57) ABSTRACT

In-process systems and methods for treating coal combustion products with property-enhancing additives are disclosed. Coal combustion products such as fly ash are collected upon their formation and are contemporaneously treated with additives such as dispersants, rheology modifiers, retarders and accelerators to improve properties of the treated products when they are used in cement, concrete, mortar and other hydraulic mixtures.

### CROSS-REFERENCE TO RELATED APPLICATION

This application is a continuation-in-part of U.S. patent application Ser. No. 12/889,100 filed Sep. 23, 2010, which claims the benefit of U.S. Provisional Patent Application Ser. No. 61/245,594 filed Sep. 24, 2009. This application also claims the benefit of U.S. Provisional Patent Application Ser. No. 61/585,694 filed Jan. 12, 2012 and U.S. Provisional Patent Application Ser. No. 61/586,728 filed Jan. 13, 2012. All of these applications are incorporated herein by reference.

### FIELD OF THE INVENTION

The present invention relates to the treatment of coal combustion products, and more particularly relates to the addition of property-enhancing additives upon the formation of coal combustion products to improve or control properties when the treated coal combustion products are added to concrete and other hydraulic mixtures.

### BACKGROUND INFORMATION

Concrete and other hydraulic mixtures used for construction rely primarily on the manufacture of Portland cement clinker as the main binder controlling the rate of development of mechanical properties. The manufacture of Portland cement clinker is energy intensive and releases large amounts of carbon dioxide into the atmosphere. To reduce the environmental impact of cement and concrete manufacture, supplementary materials with lower carbon dioxide footprint are used to partially replace Portland cement clinker as the binder in hydraulic mixtures.

Large amounts of coal ash and other coal combustion products are generated worldwide from the burning of coal as fuel for electricity generation and other energy intensive applications. A large amount of coal combustion byproducts are disposed of in landfills, at a high economical and environmental cost. Existing methods to beneficiate coal ash so as to make them suitable for other uses, such as in construction, generally do not enable 100% usage of coal ashes in beneficial applications. Furthermore, existing treatment methods commonly either use cost ineffective application of chemicals, or require treatment at a separate facility from where the coal combustion takes place, therefore incurring additional transportation costs and capital investments. Currently, most changes made to beneficiate coal combustion products are strictly related to the cleaning or sequestration of harmful chemicals within the coal combustion product.

Unfortunately, the use of coal ash and other coal combustion products in concrete has many drawbacks. For example, addition of fly ash to concrete often results in a product with low early strength development due to a low reactivity of the fly ash when used as cement replacement in concrete.

For example, although fly ash production in the United States for 1998 was in excess of 55 million tons, less than 20 million tons of fly ash were used in building product materials and other applications. Consequently, the reactivity of the ash when used as a cement replacement is a key factor retarding its wider use in current markets and the expansion of its use to other markets.

### SUMMARY OF THE INVENTION

The present invention provides a system and process in which property-enhancing additives are injected at or immediately before or after the fly ash collection system of a coal combustion plant, typically bag houses or electrostatic precipitators, to improve or customize the rheological behavior of ash particles formed during combustion, thereby optimizing the rheological and mechanical performance of the resulting treated coal combustion product. The additives may enhance the performance of the resulting treated coal combustion product through mechanisms including chemical and physical interaction with the surfaces of treated coal combustion product particles, thus enhancing the rheology and/or reactivity of the treated coal combustion product. The present invention is very cost effective since it does not require a separate treatment chamber. Furthermore, the present invention provides a system and method to inject and dose property-enhancing additives and obtain a homogeneous mixture of additives and treated coal combustion products, where only minor additions to existing fly ash collection systems are required.

The present invention also provides concrete, mortar and other hydraulic mixtures comprising Portland cement clinker and coal combustion products for use in construction and other industries. The invention provides a method for optimizing the rheological properties of treated coal combustion products while also improving on the rate of development of mechanical properties in hydraulic mixtures containing coal combustion products. The invention further relates to such hydraulic mixtures, e.g., concrete and mortar, that contain in-boiler modified coal combustion products that has been modified by the addition chemical admixtures for the purpose of increasing the rheological and mechanical properties of the treated coal combustion product.

An aspect of the present invention is to provide an in-process system for treating coal combustion products comprising: a coal combustion product inlet connected to a source of the coal combustion product, a property-enhancing additive inlet connected to a source of the property-enhancing additive, a mixer in flow communication with the coal combustion product inlet and the property-enhancing additive inlet, and a treated coal combustion product outlet in flow communication with the mixer.

Another aspect of the present invention is to provide an in-process method of treating a coal combustion product comprising: feeding the coal combustion product from a source of the coal combustion product contemporaneously with the formation of the coal combustion product into a mixer, feeding a property-enhancing additive into the mixer, and mixing the coal combustion product and the property-enhancing additive in the mixer to produce a treated coal combustion product.

A further aspect of the present invention is to provide an in-process method of treating a coal combustion product comprising adding a property-enhancing additive to the coal combustion product comprising dispersants, accelerators, retarders, air entrainers, coloring agents, shrinkage reducing admixtures and combinations thereof.

These and other aspects of the present invention will be more apparent from the following description.

### BRIEF DESCRIPTION OF THE DRAWINGS

FIG. 1 is a partially schematic diagram of certain elements of a coal-fired power plant showing a system for adding property-enhancing additives to coal combustion products upon their formation in accordance with an embodiment of the present invention.

FIG. 2 is a partially schematic diagram illustrating a system for adding property-enhancing additives to coal combustion products during operation of a coal-filed power plant in accordance with an embodiment of the present invention.

### DETAILED DESCRIPTION

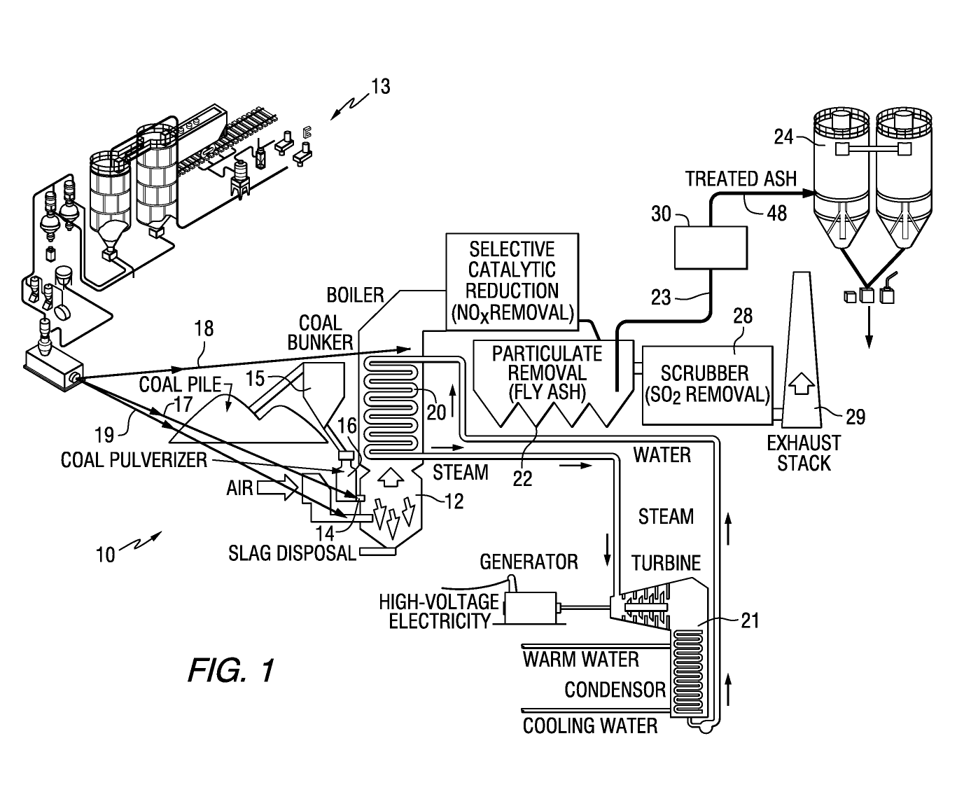

FIG. 1 schematically illustrates a coal-fired power plant 10 in accordance with an embodiment of the invention. The power plant includes a combustion chamber 12 such as a conventional tangential firing burner configuration. Pulverized coal is introduced into the combustion chamber 12 via at least one coal inlet line 14. A coal hopper 15 feeds into a coal pulverizer 16 which comminutes the coal to the desired particle size for introduction into the combustion chamber 12. The pulverized coal may be mixed with hot air and blown through the inlet(s) 14 into the combustion chamber 12 where the coal is burned.

Water flows through tube-lined walls of the boiler 20, where it is heated by the combusted fuel to form steam that passes to a steam turbine 21. Combustion products pass from the boiler region to a particulate collection region 22 where the solid combustion products are collected and transferred by an inlet line 23 to a coal combustion product treatment system 30, which is described in more detail below. After passing through the treatment system 30, the treated coal combustion product is transferred to hoppers 24. Exhaust gas passes through a scrubber 28 and is vented through a stack 29.

The coal combustion product, e.g., fly ash, is essentially formed from the combustion gases as they rise from the combustion zone and coalesce above that zone. Typically, when temperatures are in the range of 1,800-2,200° F., these gases form predominantly amorphous hollow spheres. The composition of the fly ash depends upon the chemistry of the coal being used. For example, the fly ash may include significant amounts of alumina-silicate from the combustion of bituminous coal, or may include significant amounts of calcium-alumina-silicate from the combustion of a sub-bituminous coal. In accordance with the present invention, the coal combustion product is transferred to the treatment system contemporaneously with its formation and collection in the particulate collection region 22, typically at a temperature above ambient, for example, from 100° F. to 250° F. or above.

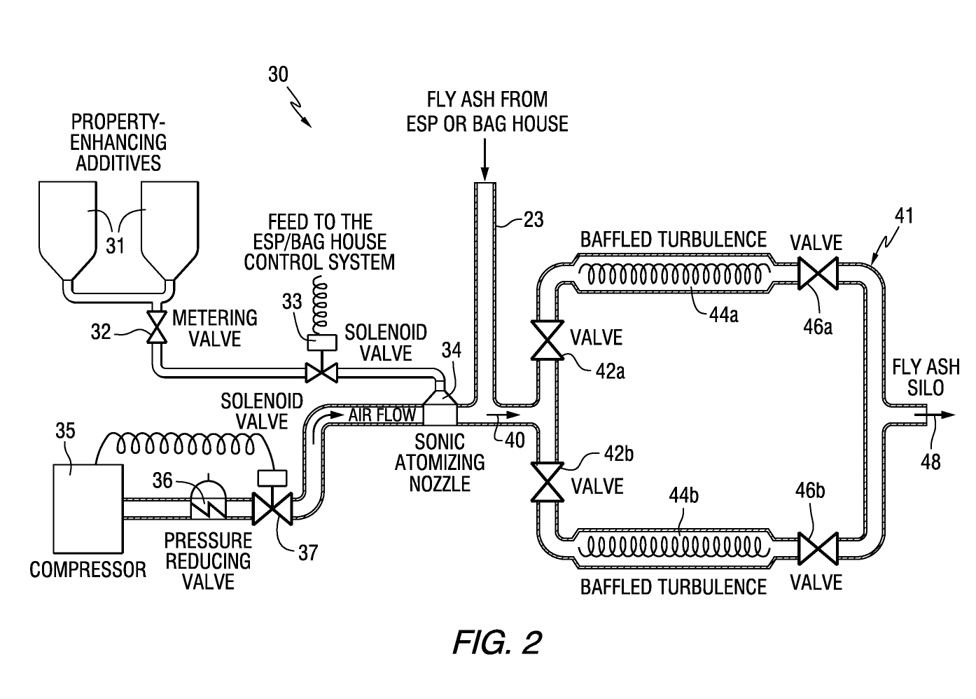

As shown in FIG. 2, the coal combustion product treatment system 30 includes an inlet line 23 through which the coal combustion product passes as it is being generated in the coal-fired power plant 10 and collected in the particulate collection region 22. The treatment system 30 includes storage hoppers 31 for the property-enhancing additives, which are described in more detail below. The property-enhancing additives are provided in a flowable form, such as particulates, powders and liquids, and are fed through a metering valve 32 to a solenoid valve 33 that may be controlled by an electronic feed to a control system, such as the control system for the fly ash bag house. For example, the control system may open the solenoid valve 33 when a signal is received from the bag emptying system or blow down in the bag house, or by the rapping frequency of electrostatic precipitators conventionally used in coal-fired power plants. The flow of the property-enhancing material may thus be coordinated with the flow of the combustion product from the collection region 22 through the inlet line 23. A controlled flow of the property-enhancing material is fed to a sonic atomizing nozzle 34.

The system 30 includes a compressor 35, pressure reducing valve 36 and solenoid valve 37 for delivering a pressurized air flow to the sonic atomizing nozzle 34. The solenoid valve 37 may be connected to a control system, such as the bag house control system, to selectively control the flow and pressure of the pressurized air flow in coordination with the flow of the property-enhancing additives.

After the property-enhancing additives have passed through the atomizing nozzle, they are combined with the coal combustion product entering through the inlet line 23 to create a mixture 40 that passes into a mixer 41 where they are intimately combined. In the embodiment shown, the mixer 41 comprises inlet valves 42a and 42b, baffled mixers 44a and 44b, and outlet valves 46a and 46b. The baffled mixers may include any suitable baffle structure that creates a tortuous path for the coal combustion product and strength-enhancing additive to interact and mix. The mixture then exits the mixer 41 by an outlet line 48. The mixture may be stored in any suitable manner, such as the hoppers 24 shown in FIG. 1.

In one embodiment of the invention, the property-enhancing additives are injected, e.g., in powder or liquid form, at the appropriate temperature regime at or immediately before or after the fly ash collection system. The property-enhancing additives are thus added contemporaneously with the formation of the coal combustion product, e.g., without being stored in a separate hopper or other storage container before the property-enhancing additives are added. As used herein, the term “property-enhancing additives” means a material, that when added to a treated coal combustion product, improves or controls at least one mechanical or processing property when the modified treated coal combustion product is subsequently used in the production of a cementitious material such as concrete, mortar, cement and other similar hydraulic mixtures. Mechanical properties include compressive strength development, set time, tensile strength development, and the like. Processing properties include rheology of the hydraulic mixture, dispersability of the modified treated coal combustion product in the hydraulic mixture, slump characteristics of the hydraulic mixture, and the like.

The property-enhancing additives may include lignin-based additives, poly-carboxylates, alkanolamines, ethylene glycols, polyethylene glycols, melamines, naphtalenes, lignosulfonates, polycarboxylic acids, fatty acids, formates, nitrates, nitrites, polyacrylates, polyalcylene glycols, polysaccharides, calcium salts, alkali salts, water soluble inorganic salts, and the like. Polymers may act as dispersants and/or surfactants. Inorganic or organic salts in aqueous solution may be used. For example, admixtures may be formulated using polymers and inorganic salts.

Dispersants may include polymers derived from polycarboxylic acids (0.3-1 weight percent), lignosulphonates (1-3 weight percent), polysaccharides (0.1-0.3 weight percent), sulfonated melamine formaldehyde condensate (1-3 weight percent), and sulphonated naphthalene formaldehyde condensate (1-3 weight percent), wherein the weight percentages are based on the weight of the coal combustion product to which the additives are added. Viscosity modifying agents include polymers derived from polysaccharides (1-3 weight percent) and cellulose (1-3 weight percent). Retarders include lignosulphonates (1-3 weight percent), polysaccharides (0.1-0.3 weight percent), and phospnonates (0.1-0.5 weight percent). Accelerators include calcium salts (1-3 weight percent), alkali salts (1-3 weight percent), water soluble thiocyanates (0.1-0.3 weight percent), and alkanolamines (0.05-0.5 weight percent). Corrosion inhibitors include nitrites (1-3 weight percent) and nitrates (1-3 weight percent). Grinding aids that may also act as accelerators include higher alcohols or alkanolamines (0.05-0.5 weight percent). Shrinkage reducing agents include water surface tension reducing polymers (1-3 weight percent) and higher glycols (1-3 weight percent). Coloring agents include inorganic or organic colorants (1-5 weight percent).

The property-enhancing additives may be added before or after the fly ash collection system, depending on the thermal stability of the additives and if the residual heat in the fly ash can be used to drive off excess water in the admixture to prevent excessive wetting and caking of the fly ash. In certain embodiments, the property-enhancing additives are introduced at or immediately before or after a fly ash collection system to optimize the rheological and mechanical properties of the resulting treated coal combustion product. The use of moderate heat, e.g., provided by the combustion products while still at elevated temperatures, and pressurized flow, create a reaction chamber for intimate mixing and partial interaction of all reactive and non-reactive particles. The fine powders containing active ingredients among the aforementioned chemical additives may be introduced into the transfer piping of the collection system between the bag house or the electrostatic precipitator and the coal combustion product storage silos.

In one embodiment, the desired dosage of the strength-enhancing additives is determined by the flow rate of the high pressure air stream containing the powder with the additives. The flow rate may be measured using an opacity meter or the like. Another aspect of the invention is to use methods to measure components such as silica, alumina, CaO and other reactive and non-reactive elements, as well as operational and chemical parameters such as temperature variations, total amorphous content or variations in chemical compositions by use of sensors as well as X-ray diffraction methods, including Rietvield analysis, X-ray fluorescence or any other methods to identify said parameters. The measurements of operational parameters may be fed into the process control system, which adjusts the dosage and selection of the additives mentioned above to attain desired target values.

In accordance with an embodiment of the present invention as shown in FIG. 1, other additives, such as those disclosed in U.S. patent application Ser. No. 12/889,100, may be co-combusted with the coal during the combustion process. Such additives may be introduced from a delivery system 13 through one or more inlet lines 17, 18 and 19 to the combustion chamber 12 for co-combustion with the coal. The additive delivery system 13 may comprise conventional particulate material storage hoppers, metering systems and delivery systems for delivering the additives to the inlet lines 17, 18 and/or 19.

Suitable additives may include limestone, concrete, kaolin, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hull, rice hull ash, zeolites, limestone quarry dust, red mud, ground mine tailings, oil shale fines, bottom ash, dry stored fly ash, landfilled fly ash, ponded flyash, spodumene lithium aluminum silicate materials, lithium-containing ores and other waste or low-cost materials containing calcium oxide, silicon dioxide and aluminum oxide.

The following example is intended to illustrate various aspects of the invention, but is not intended to limit the scope of the invention.

### Example

Bituminous and sub-bituminous coal were mixed with property-enhancing additives of the types and amounts listed in Table 1 below. Each mixture was then introduced into the combustion zone of a tangential firing burner. Admixtures of the types and amounts listed in Table 1 below were added to the combustion products immediately after fly ash collection as schematically shown in FIG. 1.

TABLE 1
Combustion Products with Additives

| | | | After-boiler |
|---|---|---|---|
| | | In-boiler | Property- |
| CP Sample | Coal type | Additives | Enhancing |
| No. | (wt %) | (wt %) | Additives (wt %) |
| 1 | 75.1 Bituminous | 18 limestone | 0.15 triethanolamine |
| | | 3 GGBFS¹ | 1.0 lignosulphonate |
| | | 3 recycled | |
| | | concrete² | |
| | | 0.3 recycle glass | |
| | | 0.6 kaolin³ | |
| 2 | 75.1 Bituminous | 18 limestone | none |
| | | 3 GGBFS¹ | |
| | | 3 recycled | |
| | | concrete² | |
| | | 0.3 recycle glass | |
| | | 0.6 kaolin³ | |
| 3 | 88.3 Sub- | 7.2 limestone | 0.15 triethanolamine |
| | bituminous | 1.7 GGBFS¹ | 1.0 lignosulphonate |
| | | 1.7 recycled | |
| | | concrete² | |
| | | 0.9 kaolin³ | |
| 4 | 88.3 Sub- | 7.2 limestone | none |
| | bituminous | 1.7 GGBFS¹ | |
| | | 1.7 recycled | |
| | | concrete² | |
| | | 0.9 kaolin³ | |

¹Ground recycled concrete comprises about 68 weight percent SiO₂, about 9 weight percent Al₂O₃, about 7.5 weight percent CaO, about 4 weight percent Fe₂O₃, about 1.2 weight percent MnO, and about 8 weight percent moisture.
²Ground granulated blast furnace slag comprises about 40 weight percent SiO₂, about 39 weight percent CaO, about 13.5 weight percent Al₂O₃, about 3.5 weight percent MgO, and about 1.8 weight percent Fe₂O₃.
³During the process, the kaolin is converted to metakaolin, which comprises Al₂Si₂O₅(OH)₄.

The combustion product samples of in Table 1 were mixed with Portland cement in ratio of 30 weight percent combustion product and 70 weight percent Portland cement. Each blended mixture was combined with sand and water to prepare four micro concrete mixtures according to the mixture proportions in Table 2 using a standard laboratory mixer. Each micro concrete was tested for slump life and compressive strength development and isothermal calorimetry.

TABLE 2
Micro Concrete Mixture Design

| Materials | Mass (g) |
|---|---|
| Graded EN 196 Sand | 1350 |
| Portland Cement | 496 |
| Combustion product | 213 |
| Water | 283 |

Tables 3 and 4 shows the slump life and compressive strength development for the four micro concrete mixtures tested.

TABLE 3
Slump Life of Microconcrete

| | Time after | Mini- | Time after | Mini- | Time after | Mini- |
|---|---|---|---|---|---|---|
| | mixing | slump | mixing | slump | mixing | slump |
| CP | (min) | (mm) | (min) | (mm) | (min) | (mm) |
| 1 | 8 | 110 | 20 | 95 | 45 | 65 |
| 2 | 8 | 45 | 20 | Too stiff | 45 | Too stiff |
| | | | | to measure | | to measure |
| 3 | 8 | 125 | 20 | 105 | 45 | 80 |
| 4 | 8 | 35 | 20 | Too stiff | 45 | Too stiff |
| | | | | to measure | | to measure |

TABLE 4
Compressive Strength Development of Microconcrete Using Standard
EN-196 Mortar Bars

| | | Compr. | | Compr. | | Compr. |
|---|---|---|---|---|---|---|
| | Testing age | Strength | Testing | Strength | Testing | Strength |
| CP | (days) | (MPa) | age (days) | (MPa) | age (days) | (MPa) |
| 1 | 2 | 12.5 | 7 | 37.3 | 28 | 55.3 |
| 2 | 2 | 10.2 | 7 | 33.1 | 28 | 49.1 |
| 3 | 2 | 14.3 | 7 | 40.4 | 28 | 52.3 |
| 4 | 2 | 12.1 | 7 | 38.3 | 28 | 50.5 |

The present invention provides a system and method to reduce disposal of coal combustion ashes in landfills by converting them into higher value hydraulic binders, usable as a substitute of cement in quantities, e.g., in excess of 40 percent of substitution. Another advantage of the invention is that it provides a cost-effective alternative to other methods to beneficiate coal combustion ashes, by applying the injection of treatment and materials in the coal combustion facility rather than at a separate facility. The invention enables treatment of coal combustion products as a part of the normal process of power generation, thereby reducing the need for transportation to a separate facility and avoiding the application of additional chemicals.

Whereas particular embodiments of this invention have been described above for purposes of illustration, it will be evident to those skilled in the art that numerous variations of the details of the present invention may be made without departing from the invention as defined in the appended claims.

What is claimed is:

1. An in-process system for treating coal combustion products comprising:
a coal combustion product inlet connected to a source of the coal combustion product;
a property-enhancing additive inlet connected to a source of the property-enhancing additive;
a mixer in flow communication with the coal combustion product inlet and the property-enhancing additive inlet; and
a treated coal combustion product outlet in flow communication with the mixer.

2. The in-process system of claim 1, wherein the source of the coal combustion product comprises a bag house or an electrostatic precipitator of a coal-fired power plant.

3. The in-process system of claim 2, wherein the coal combustion product is gravity fed from the source of the coal combustion product to the coal combustion product inlet.

4. The in-process system of claim 1, further comprising a property-enhancing material flow valve controlling the flow of the property-enhancing material based on a flow of the coal combustion product in the coal combustion product inlet.

5. The in-process system of claim 1, further comprising an atomizer structured and arranged to disperse the property-enhancing additive in a pressurized gas prior to mixing of the property-enhancing additive with the coal combustion product.

6. The in-process system of claim 1, wherein the mixer comprises at least one baffle structured and arranged to generate turbulent flow of the coal combustion product together with the property-enhancing additive.

7. An in-process method of treating a coal combustion product comprising:
feeding the coal combustion product from a source of the coal combustion product contemporaneously with the formation of the coal combustion product into a mixer;
feeding a property-enhancing additive into the mixer; and
mixing the coal combustion product and the property-enhancing additive in the mixer to produce a treated coal combustion product.

8. The method of claim 7, wherein the coal combustion product is fed into the mixer at a feed temperature above ambient temperature.

9. The method of claim 7, wherein the feed temperature is above 100° F.

10. The method of claim 7, wherein the property-enhancing additive comprises lignosulfonate, sulfonated melamine formaldehyde condensate, sulphonated naphthalene formaldehyde condensate, polycarboxylic acids and combinations thereof.

11. The method of claim 7, wherein the property-enhancing additive comprises water soluble calcium salts, water soluble alkali salts, water soluble nitrites, water soluble nitrates, water soluble thiocyanates, alkanolamines and combinations thereof.

12. The method of claim 7, wherein the property-enhancing additive comprises polysaccharides, phosphonates, phosphates and combinations thereof.

13. The method of claim 7, wherein the property-enhancing additive comprises from 0.02 to 3 weight percent of the combined total weight of the coal combustion product and the property-enhancing additive.

14. The method of claim 7, wherein the coal combustion product comprises fly ash.

15. The method of claim 7, further comprising adding the treated coal combustion product to a cement mixture.

16. The method of claim 15, wherein the property-enhancing additive affects at least one property of the cement selected from rheology, compressive strength development, setting time, tensile strength development and color.

17. An in-process method of treating a coal combustion product comprising adding a property-enhancing additive to the coal combustion product comprising dispersants, accelerators, retarders, air entrainers, coloring agents, shrinkage reducing admixtures and combinations thereof.
